(19) United States
(12) Patent Application Publication
(10) Pub. No.: US 2015/0159856 A1
(43) Pub. Date: Jun. 11, 2015

(54) ILLUMINATED MAKEUP MIRROR SET

(71) Applicants: Kazufumi Adachi, Kawasaki-shi (JP); Kazunaga Ida, Kawasaki-shi (JP); Taku Ito, Kawasaki-shi (JP); Harumi Nakamura, Kawasaki-shi (JP); Meiji Kitamura, Kawasaki-shi (JP); Takeshi Nakamura, Kawasaki-shi (JP); Yosuke Sato, Yonezawa-shi (JP); Takuo Shinohara, Kawasaki-shi (JP)

(72) Inventors: Kazufumi Adachi, Kawasaki-shi (JP); Kazunaga Ida, Kawasaki-shi (JP); Taku Ito, Kawasaki-shi (JP); Harumi Nakamura, Kawasaki-shi (JP); Meiji Kitamura, Kawasaki-shi (JP); Takeshi Nakamura, Kawasaki-shi (JP); Yosuke Sato, Yonezawa-shi (JP); Takuo Shinohara, Kawasaki-shi (JP)

(73) Assignees: TOHOKU PIONEER CORPORATION, Tendo-shi, Yamagata (JP); PIONEER CORPORATION, Kawasaki-shi, Kanagawa (JP)

(21) Appl. No.: 14/348,233

(22) PCT Filed: Sep. 30, 2011
(86) PCT No.: PCT/JP2011/072576

§ 371 Date: Jun. 19, 2014

(51) Int. Cl. F21V 33/00; H04R 1/02; A47G 1/02; F21V 23/00

(52) U.S. Cl. CPC F21V 33/004; F21V 33/0056; F21V 23/003; H04R 1/028; A47G 1/02; F21W 2131/302

(57) ABSTRACT

An illuminated makeup mirror set includes: a mirror unit; a surface light source with adjustable color that is used to illuminate a makeup subject; a setting unit for setting illumination conditions with the surface light source according to an input operation; an adjustment unit for adjusting color and brightness of the surface light source according to the illumination conditions set by the setting unit; a speaker; and a playback unit that stores a plurality of musical pieces as data, plays a musical piece selected from the plurality of musical pieces according to the illumination conditions and time of illumination with the surface light source, and causes the speaker to output the selected musical piece as a reproduced sound.

### TECHNICAL FIELD

The present invention relates to an illuminated makeup mirror set including a mirror unit and a light source for illumination.

### BACKGROUND ART

When makeup (including hair styling) is put on a model or actress, illumination is necessary to clearly reflect the process of the makeup in a mirror. One known illumination light fixture is a so-called Hollywood light fixture including a plurality of light sources arranged in a row. An illuminated makeup mirror set including a makeup mirror and Hollywood light fixtures disposed on opposite sides of the makeup mirror has been commercially available as a makeup case. In these Hollywood light fixtures, the light sources used are generally incandescent lamps, which are point light sources.

In addition, an illuminated makeup mirror set including a makeup mirror and a lighting fixture with variable illumination characteristics is known (Patent Document 1). In the illuminated makeup mirror set in Patent Document 1, data of the illumination characteristics of illumination light for a scene selected by the user is acquired from a possible scene illumination database pre-stored in a memory unit. Then a control signal for illumination with the acquired illumination characteristics is supplied to the lighting fixture, and the lighting fixture provides illumination according to the control signal.

### CITATION LIST

### Patent Documents

Patent Document 1: Japanese Patent Application Laid-Open No. 2009-125114

### SUMMARY OF THE INVENTION

### Problem to be Solved by the Invention

In the conventional illuminated makeup mirror set, the illumination conditions optimal for the selected scene can be set as described above. However, the mood of the makeup subject whose image is reflected in the mirror surface of the makeup mirror set is not taken into consideration. Therefore, the makeup subject does not obtain enough satisfaction with the makeup, and makeup time increases significantly for some cases.

One example of problems to be solved by the present invention is the above-described drawback, and it is an object of the present invention to provide an illuminated makeup mirror set that allows a makeup subject to wear makeup in a good mood.

### Means to Solve the Problem

An illuminated makeup mirror set in an invention according to claim 1 is an illuminated makeup mirror set comprising a mirror unit, the illuminated makeup mirror set further comprising: a surface light source with adjustable color that is used to illuminate a makeup subject; a setting unit for setting illumination conditions with the surface light source according to an input operation; an adjustment unit for adjusting color and brightness of the surface light source according to the illumination conditions set by the setting unit; a speaker; and a playback unit that stores a plurality of musical pieces as data, plays a musical piece selected from the plurality of musical pieces according to the illumination conditions and time of illumination with the surface light source, and causes the speaker to output the selected musical piece as a reproduced sound.

### DESCRIPTION OF EMBODIMENTS

The illuminated makeup mirror set in the invention according to claim 1 includes a playback unit that stores a plurality of musical pieces as data, plays a musical piece selected from the plurality of musical pieces according to the illumination conditions and time of illumination with the surface light source, and outputs the selected musical piece as a reproduced sound from the speaker. Therefore, when makeup is applied to the makeup subject, the musical piece allows the makeup subject to be in a high mood or to relax as the makeup progresses. More specifically, the makeup can be applied to the makeup subject in a good mood. Therefore, the makeup subject can obtain higher satisfaction with the makeup, and the makeup time can thereby be reduced.

### BRIEF DESCRIPTION OF DRAWINGS

FIG. 1 is an external view of an illuminated makeup mirror set in an embodiment of the present invention.

FIG. 2 is a diagram illustrating a hinge mechanism in the makeup mirror set in FIG. 1.

FIG. 3 is an external view of the makeup mirror set in FIG. 1 in a folded state.

FIG. 4 is a cross-sectional view illustrating the structure of an organic EL panel in the makeup mirror set in FIG. 1.

FIG. 5 is a block diagram showing the configuration of a driving unit in the makeup mirror set in FIG. 1.

FIG. 6 is a diagram illustrating respective push buttons in an operation unit in the makeup mirror set in FIG. 1.

FIG. 7 is a flowchart showing an operation of a playback processing unit in FIG. 5.

FIG. 8 is a block diagram illustrating the configuration of a driving unit in the illuminated makeup mirror set as another embodiment of the present invention.

FIG. 9 is an external view of an illuminated makeup mirror set including a camera in the driving unit in FIG. 8.

FIG. 10 is an external view of angle-adjustable organic EL panels for the makeup mirror set in FIG. 1.

FIG. 11 is an external view of an illuminated makeup mirror set including single surface light sources each having a light-emitting surface divided into a plurality of regions driven independently.

### EMBODIMENTS

Embodiments of the present invention will next be described in detail with reference to the drawings.

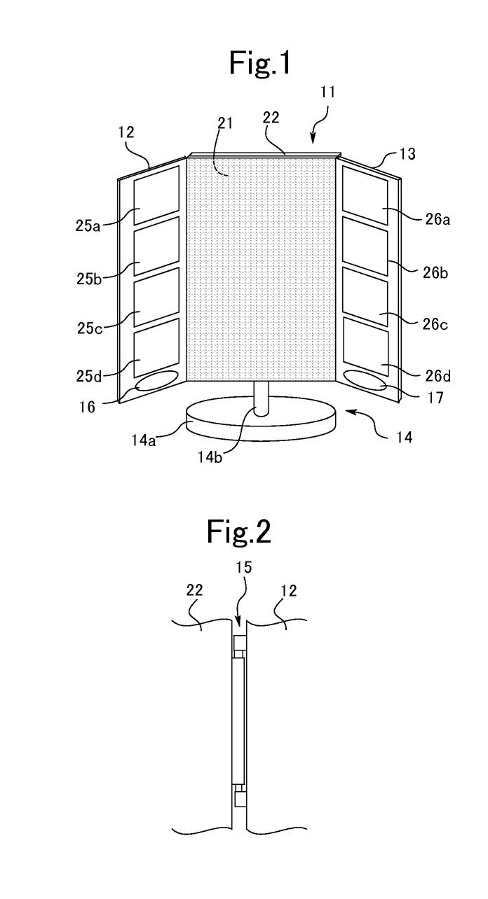

FIG. 1 shows an illuminated makeup mirror set, which is an embodiment of the invention according to claim 1. This makeup mirror set includes a mirror unit 11, left and right side plates 12 and 13, and a support 14. The mirror unit 11 includes a rectangular mirror 21 and a flat plate 22 affixed to the rear face of the mirror 21. The flat plate 22 is formed from a resin, wood, or a metal and may have the same size as the mirror 21 or may be slightly larger than the mirror 21. The left side plate 12 is connected to the left edge of the mirror unit 11 such that the angle therebetween is freely adjustable, and the right side plate 13 is connected to the right edge of the mirror unit 11 such that the angle therebetween is freely adjustable. A hinge mechanism 15 is formed between the mirror unit 11 and each of the side plates 12 and 13, as shown in FIG. 2, and these hinge mechanisms 15 allow the above connection angles to be freely adjustable. Each of these angles can be adjusted within the range of from an angle at which the mirror unit 11 and one of the side plates 12 and 13 are substantially flush with each other to an angle at which the one of the side plates 12 and 13 is folded with respect to the mirror unit 11.

The vertical length (in the up-and-down direction) of each of the side plates 12 and 13 is the same as the vertical length of the mirror unit 11, but the horizontal length (in the left-and-right direction) of each of the side plates 12 and 13 is equal to or less than ½ of the horizontal length of the mirror unit 11.

Four organic EL (Electro Luminescence) panels (surface light sources) 25a to 25d and four organic EL panels 26a to 26d used to illuminate the makeup subject are vertically arranged on and attached to the surfaces of the side plates 12 and 13, respectively. The organic EL panels 25a to 25d and 26a to 26d are identical and have a square shape of, for example, 13 cm×13 cm. Flat speakers 16 and 17 are attached to the side plates 12 and 13 at positions below the organic EL panels 25d and 26d.

The support 14 includes an elliptical flat base 14a and a strut 14b, and the strut 14b is vertically connected to the base 14a. The strut 14b of the support 14 is detachably connected to the mirror unit 11 to support the mirror unit 11 including the side plates 12 and 13. For example, a connection hole (not shown) is formed in a lower portion of the mirror unit 11. The top end portion of the strut 14b is inserted into the connection hole, and the support 14 is thereby connected to the mirror unit 11.

In the makeup mirror set in FIG. 1 having the above-described configuration, the user such as a makeup artist operates the side plates 12 and 13 with their joints to the mirror unit 11 (the hinge mechanisms 15) serving as rotation axes to thereby adjust the angles between the mirror unit 11 and the side plates 12 and 13. More specifically, the angles between the mirror unit 11 and the side plates 12 and 13 can be adjusted such that an image of a makeup subject such as a model that is reflected in the mirror surface of the mirror 21 is preferably illuminated with light emitted from the organic EL panels 25a to 25d and 26a to 26d on the side plates 12 and 13.

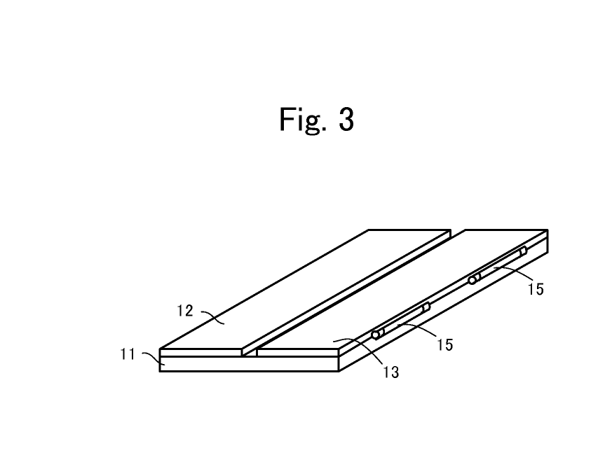

The side plates 12 and 13 can be folded respectively as shown in FIG. 3 with the organic EL panels 25a to 25d and 26a to 26d disposed thereon. In the folded state, the side plates 12 and 13 are not in contact with each other. Since the thickness of the organic EL panels 25a to 25d and 26a to 26d is small, the organic EL panels 25a to 25d and 26a to 26d do not come into pressure contact with the mirror 21.

The support 14 can be detached from the mirror unit 11 to separate the support 14 from the mirror unit 11 and the side plates 12 and 13. Then the side plates 12 and 13 can be folded with respect to the mirror unit 11 as described above, whereby the makeup mirror set can be easily conveyed.

Next, a description will be given of the organic EL panels 25a to 25d and 26a to 26d in the makeup mirror set in FIG. 1 and their driving system.

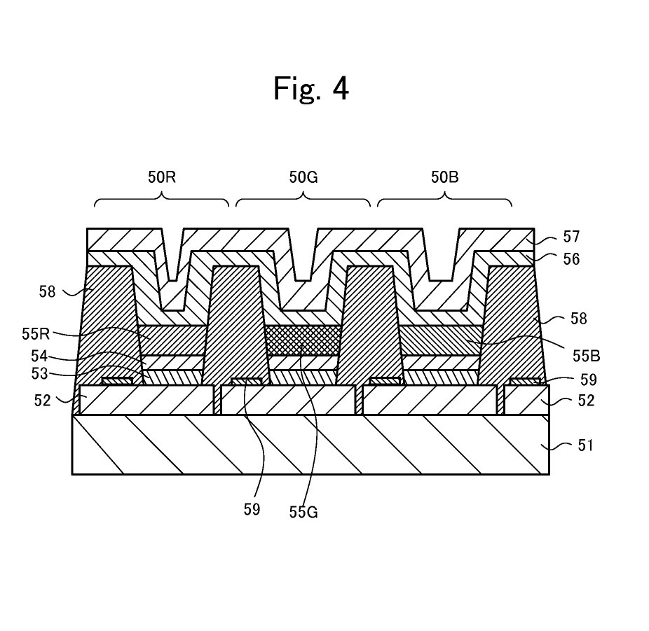

Each of the organic EL panels 25a to 25d and 26a to 26d is a full-color illumination light-emitting panel, and stripe-shaped organic EL elements 50R, 50G, and 50B with emission colors of R (red), G (green), and B (blue) are formed on a glass substrate 51, as shown in FIG. 4. In FIG. 4, a cross section in a direction orthogonal to the straight stripes is shown.

Each of the organic EL elements 50R, 50G, and 50B has a structure in which an anode 52, a hole injection layer 53, a hole transport layer 54, an RGB light-emitting layer 55R, 55G, or 55B, an electron transport layer 56, and a cathode 57 are stacked in that order. The organic EL elements 50R, 50G, and 50B are partitioned by banks 58. Bus lines 59 are formed on the anodes 52 of the respective organic EL elements 50R, 50G, and 50B, and the anodes 52 are energized through the bus lines 59. Each anode 52 is formed of, for example, an ITO film formed by sputtering and having a thickness of 70 nm. Each hole injection layer 53 is formed of CuPc and has a thickness of 20 nm. Each hole transport layer 54 is formed of NPB and has a thickness of 20 nm. Each R (red) light-emitting layer 55R is formed of CPB as a host material and Ir(phq)₂tpy as a dopant. Each G (green) light-emitting layer 55G is formed of CPB as a host material and Ir(ppy)₃ as a dopant, and each B (blue) light-emitting layer 55B is formed of PAND as a host material and DPAVBi as a dopant. The thicknesses of the RGB light-emitting layers 55R, 55G, and 55B are 40 nm. Each electron transport layer 56 is formed of CsxMoOx-doped NBphen and has a thickness of 30 nm. Each cathode 57 is formed of an Al film having a thickness of 70 to 100 nm. The internal structure of each of the organic EL panels 25a to 25d and 26a to 26d is only an example, and the present invention is not limited thereto.

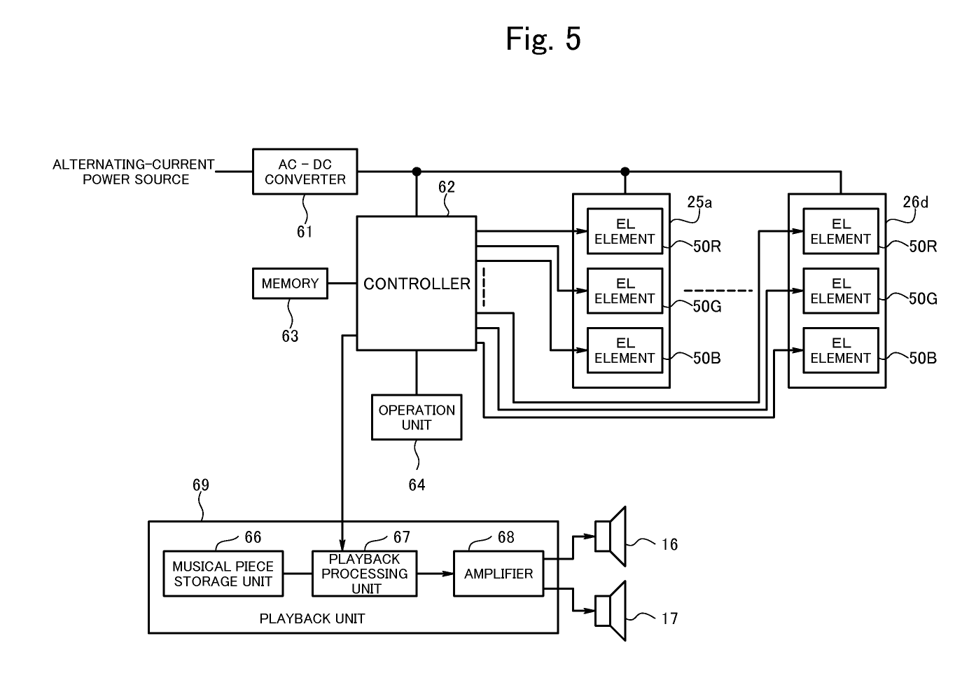

The makeup mirror set in FIG. 1 further includes a driving unit for driving the organic EL panels 25a to 25d and 26a to 26d. As shown in FIG. 5, the driving unit includes an AC-DC converter 61, a controller 62, a memory 63, and an operation unit 64. The AC-DC converter 61 converts alternating voltage to direct voltage and outputs the direct voltage. The output voltage from the AC-DC converter 61 is supplied as direct current power to the organic EL panels 25a to 25d and 26a to 26d and the controller 62. The controller 62 is operated by the output voltage from the AC-DC converter 61 as a power source and includes, for example, a CPU. The controller 62 controls the driving current for each of the RGB organic EL elements 50R, 50G, and 50B in the respective organic EL panels 25a to 25d and 26a to 26d to thereby control light emission (emission color and brightness) of each of the organic EL panels independently. The controller 62 serves as an adjustment unit for adjusting the color and brightness (luminosity) of the surface light sources.

The memory 63 and the operation unit 64 are further connected to the controller 62. Programs and data necessary for the control by the controller 62 are stored in the memory 63. The operation unit 64 is provided as a wired or wireless remote controller.

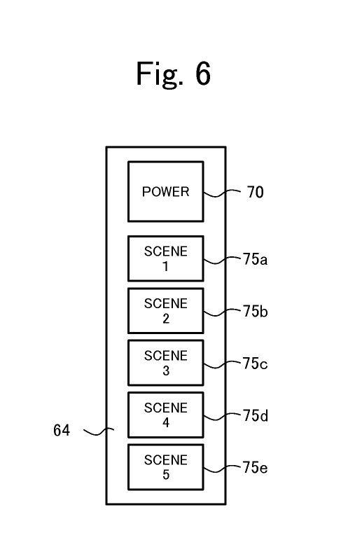

The operation unit 64 includes a power button 70 and scene buttons 75a to 75e, as shown in FIG. 6. After the user operates the power button 70 in the operation unit 64 to turn the power on, any one of the scene buttons 75a to 75e can be operated. The scene buttons 75a to 75e constitute the setting unit for setting illumination conditions of the surface light sources according to the input operations.

Illumination conditions, including color and brightness, for a plurality of scenes are pre-stored as date in the memory 63. Examples of the scenes include an office, a hotel lounge, a dinner party, a fashion show, and an outdoor location. RGB driving voltage values corresponding to optimal emission color and brightness for each of the organic EL panels 25a to 25d and 26a to 26d are stored as data in the memory 63. The number of the scene buttons 75a to 75e provided is the same as the number of the plurality of scenes stored as data in the memory 63.

The driving unit further includes a playback unit 69 including a musical piece data storage unit 66, a playback processing unit 67, and an amplifier 68. The musical piece data storage unit 66 is, for example, a hard disk device or a nonvolatile semiconductor memory. Groups of musical piece data (e.g., MP3 data) of a plurality of musical pieces that are classified according to the above scenes (i.e., the illumination conditions) are stored in the musical piece data storage unit 66. The musical pieces in each of the data groups classified according to the scenes are further classified according to the length of illumination time. In this embodiment, the musical pieces are classified according to their melody into three musical piece groups, a first illumination time musical piece group to a third illumination time musical piece group. The first illumination time musical piece group includes musical pieces with slow tempo. The second illumination time musical piece group includes musical pieces with medium tempo, and the third illumination time musical piece group includes musical pieces with up tempo. However, the musical pieces data may be classified according to their melody into categories including healing music, popular music, rock music, etc.

The playback processing unit 67 selectively reads data of a musical piece from the musical piece data storage unit 66 according to a musical piece playback instruction from the controller 62 as described later, decodes the read data of the musical piece to generate an audio signal representing the musical piece, and then supplies the audio signal to the amplifier 68.

The amplifier 68 drives the speakers 16 and 17 according to the audio signal to cause the speakers 16 and 17 to output the musical piece.

In the driving unit configured as described above, when the user presses one of the scene buttons 75a to 75e, e.g., the scene button 75a, the controller 62 reads data of the scene corresponding to the scene button 75a (i.e., the RGB values for the organic EL panels 25a to 25d and 26a to 26d) from the memory 63. The controller 62 supplies driving currents to the RGB emission organic EL elements 50R, 50G, and 50B in the organic EL panels 25a to 25d and 26a to 26d according to the read data. Therefore, when the scene button 75a is operated, illumination conditions suitable for the scene corresponding to the scene button 75a can be produced. In addition, in response to the operation of the scene button 75a, the controller 62 supplies a musical piece playback instruction including the information about the scene corresponding to the scene button 75a to the playback processing unit 67.

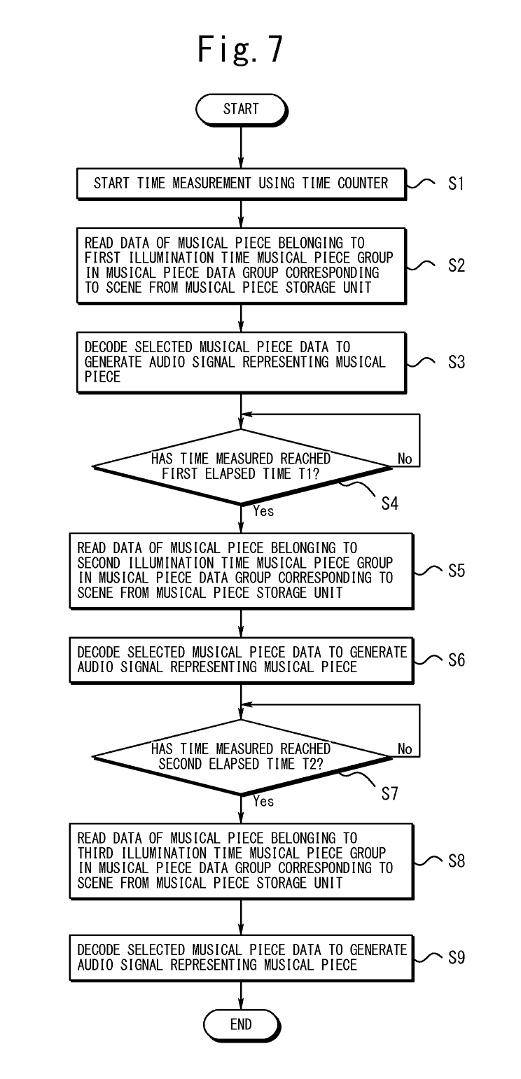

Upon reception of the musical piece playback instruction, the playback processing unit 67 starts time measurement using a time counter (not shown) as shown in FIG. 7 (step S1). Step S1 is executed to measure the time of illumination with the organic EL panels 25a to 25d and 26a to 26d started by operation of the scene button 75a. After execution of step S1, data of a musical piece in the first illumination time musical piece group belonging to the musical piece data group corresponding to the scene included, as information, in the musical piece playback instruction supplied from the controller 62 is read selectively from the musical piece data storage unit 66 (step S2). Then the read selected musical piece data is decoded to generate an audio signal representing the musical piece, and the audio signal is supplied to the amplifier 68 (step S3). The audio signal is amplified by the amplifier 68 and then supplied to the speakers 16 and 17. The speakers 16 and 17 output a playback sound for the read selected musical piece data. The playback sound is a musical piece with slow tempo that is suitable for the scene corresponding to the scene button 75a.

After execution of step S3, the playback processing unit 67 determines whether or not the time measured by the time counter has reached first elapsed time T1 (e.g., 10 minutes) (step S4). If the time measured has not reached the first elapsed time T1, the generation of the audio signal in step S3 is continued. When the generation of the audio signal for the data of the musical piece in step S3 finishes, the process may return to step S2. In this case, the data of another musical piece belonging to the first illumination time musical piece group in the musical piece data group assigned to the selected scene is selectively read from the musical piece data storage unit 66, and the read data of the musical piece is decoded to produce an audio signal.

If the determination result in step S4 shows that the time measured has reached the first elapsed time T1, the data of a musical piece in the second illumination time musical piece group in the musical piece data group assigned to the selected scene is selectively read from the musical piece data storage unit 66 (step S5). Then the read selected musical piece data is decoded to generate an audio signal representing the musical piece, and the audio signal is supplied to the amplifier 68 (step S6). The speakers 16 and 17 output a playback sound for the read selected musical piece data. The playback sound is a musical piece with medium tempo that is suitable for the scene corresponding to the scene button 75a.

After execution of step S6, a determination is made as to whether or not the time measured has reached second elapsed time T2 (e.g., 20 minutes, T2>T1) (step S7). If the time measured has not reached the second elapsed time T2, the generation of the audio signal in step S6 is continued. Even when the time measured has not reached the second elapsed time T2, if the generation of the audio signal for the data of the musical piece in step S6 finishes, the process may return to step S5. In this case, the data of another musical piece belonging to the second illumination time musical piece group in the musical piece data group assigned to the selected scene is selectively read from the musical piece data storage unit 66, and the read data of the musical piece is decoded to produce an audio signal.

If the determination result in step S7 shows that the time measured has reached the second elapsed time T2, the data of a musical piece belonging to the third illumination time musical piece group in the musical piece data group assigned to the selected scene is selectively read from the musical piece data storage unit 66 (step S8). Then the read selected musical piece data is decoded to generate an audio signal representing the musical piece, and the audio signal is supplied to the amplifier 68 (step S9). The speakers 16 and 17 output a playback sound for the read selected musical piece data. The playback sound is a musical piece with up tempo that is suitable for the scene corresponding to the scene button 75a.

When the generation of the audio signal for the data of the musical piece in step S9 finishes, the process may return to step S8. In this case, the data of another musical piece belonging to the third illumination time musical piece group in the musical piece data group assigned to the selected scene is selectively read from the musical piece data storage unit 66, and the read data of the musical piece is decoded to produce an audio signal.

As described above, during application of makeup to the makeup subject under illumination conditions suitable for the scene corresponding to the scene button 75a, a musical piece is outputted from the speakers 16 and 17. As the makeup progresses, a musical piece with, for example, faster tempo is played. This can lighten the mood of the makeup subject as the makeup progresses, and therefore the makeup subject can wear the makeup in a good mood.

In the above embodiment, the operation when the user presses the scene button 75a among the scene buttons 75a to 75e is pressed has been described. The operation when one of the scene buttons 75b to 75e except for the scene button 75a is pressed is the same as the operation when the scene button 75a is pressed. For example, when the scene button 75c is pressed, illumination conditions suitable for the scene corresponding to the scene button 75c are formed by light emitted from the organic EL panels 25a to 25d and 26a to 26d. Simultaneously, a musical piece suitable for the scene corresponding to the scene button 75c is outputted from the speakers 16 and 17 during application of makeup to the makeup subject. As the makeup progresses, a musical piece with, for example, faster tempo is played.

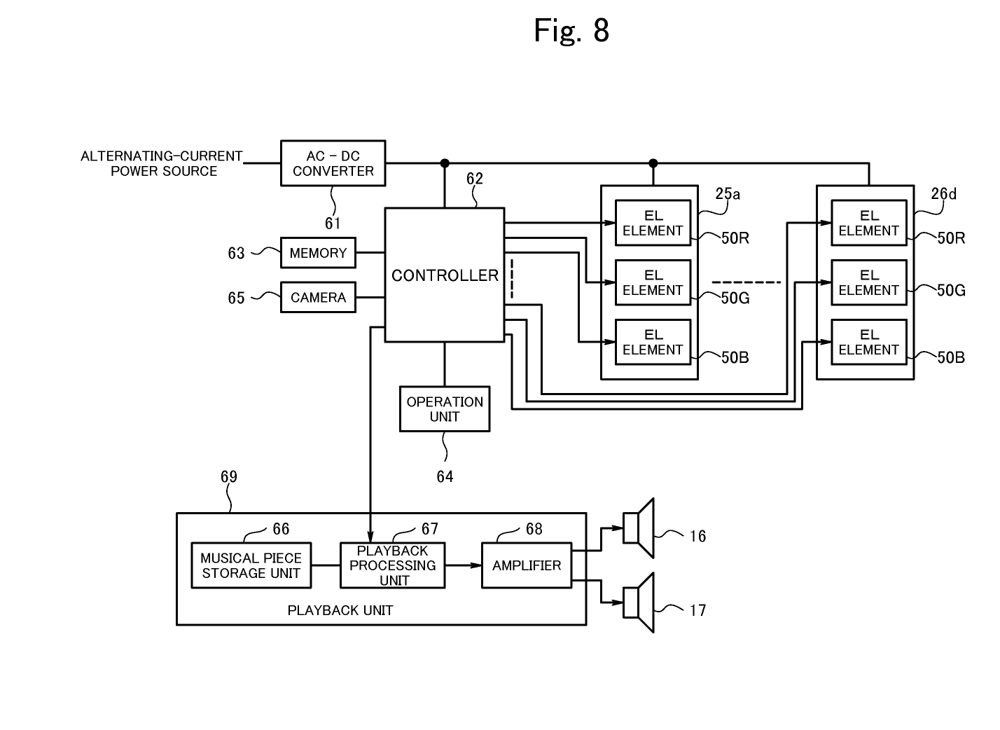

FIG. 8 shows the configuration of a driving unit in the illuminated makeup mirror set in FIG. 1 as another embodiment of the present invention. In the driving unit shown in FIG. 8, a camera 65 is connected to the controller 62. The rest of the configuration is the same as the configuration of the driving unit shown in FIG. 5, and the same reference numerals are used in FIG. 8.

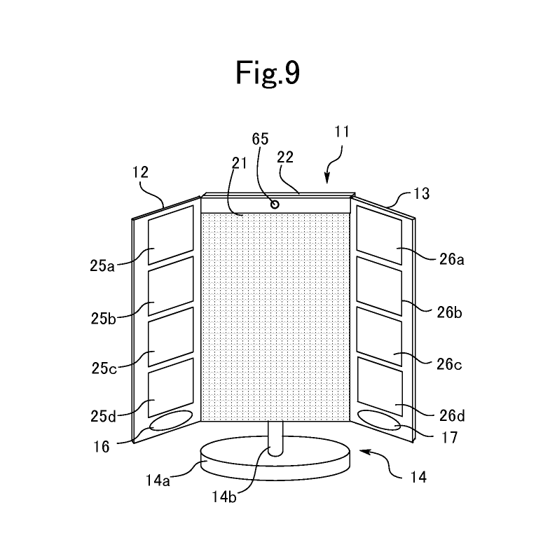

The camera 65 is attached to the upper portion of the flat plate 22 of the mirror unit 11 as shown in FIG. 9. However, the camera 65 may be disposed in any of the left and right side plates 12 and 13 and an upper plate 14, or the user may hold and operate the camera 65. In the makeup mirror set, the camera 65 captures an image of the face of makeup subject, for example, immediately after the power button 70 in the operation unit 64 is pressed and supplies the video signal of the captured image to the controller 62.

Upon reception of the supplied video signal, the controller 62 recognizes the degree of progress of the makeup on the face of the makeup subject from a subject image represented by the video signal (the controller 62 serves as a recognition unit). The degree of progress of the makeup can be determined, for example, according to the difference between the brightness of the outline of the eyes and the brightness of the skin around the eyes. The controller 62 supplies the recognized degree of progress of the makeup as information to the playback processing unit 67. In this embodiment, the degree of progress of the makeup is divided into first to third makeup progress degrees. As the makeup progresses, the recognized degree of progress of the makeup changes from the first makeup progress degree to the second makeup progress degree and then to the third makeup progress degree in that order.

The playback processing unit 67 uses the degree of progress of the makeup supplied as information from the controller 62 as information corresponding to the illumination time, selectively reads, from the musical piece data storage unit 66, the data of a musical piece in an illumination time musical piece group that corresponds to the degree of progress of the makeup and is included in a musical piece group assigned to a scene, and then decodes the data of the music piece to generate an audio signal. In the first makeup progress degree, the data of a music piece belonging to the first illumination time musical piece group is selected. In the second makeup progress degree, the data of a music piece belonging to the second illumination time musical piece group is selected. In the third makeup progress degree, the data of a music piece belonging to the third illumination time musical piece group is selected.

By recognizing the degree of progress of the makeup on the makeup subject and using the recognized information to select the data of a musical piece, the mood of the makeup subject can be lightened as the makeup progresses, and therefore the makeup subject can wear the makeup in a good mood.

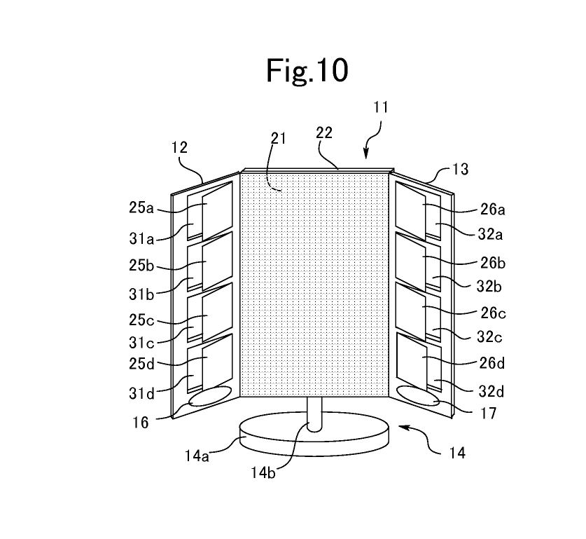

In the makeup mirror set in the above embodiment, the angles of the organic EL panels 25a to 25d and 26a to 26d with respect to the side plates 12 and 13 may be adjustable as shown in FIG. 10. In the organic EL panels 25a to 25d and 26a to 26d, their edge close to the mirror unit 11 serves as a rotation axis so that the angles of the organic EL panels 25a to 25d and 26a to 26d are adjustable. For example, the side plates 12 and 13 are connected to the organic EL panels 25a to 25d and 26a to 26d through hinge mechanisms (not shown) to allow the edges of the organic EL panels 25a to 25d and 26a to 26d close to the mirror unit 11 to serve as rotation axes. As shown in FIG. 10, openings 31a to 31d and 32a to 32d that can accommodate the organic EL panels 25a to 25d and 26a to 26d may be formed in the side plates 12 and 13 at positions corresponding to the organic EL panels 25a to 25d and 26a to 26d. When the angles of the organic EL panels 25a to 25d and 26a to 26d with respect to the side plates 12 and 13 are adjustable as described above, the angle of each of the organic EL panels can be freely adjusted, so that more suitable illumination conditions can be produced.

In the above embodiment, one set of illumination conditions is selected from a plurality of sets of preset illumination conditions according to an input operation by the user through the operation unit 64. However, the user may operate the operation unit 64 to designate RGB values or emission color and brightness for each of the organic EL panels to thereby set illumination conditions, and the organic EL panels 25a to 25d and 26a to 26d may be driven according to the set illumination conditions.

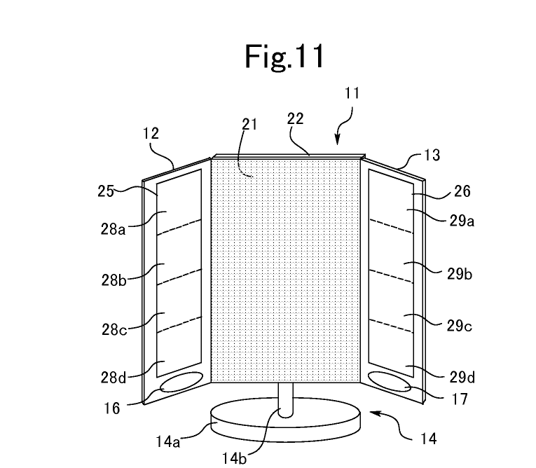

FIG. 11 shows an illuminated makeup mirror set including single surface light sources each having a light-emitting surface divided into a plurality of regions driven independently. For example, in the embodiment shown in FIG. 1, the plurality of organic EL panels 25a to 25d and 26a to 26d are attached to the side plates 12 and 13. However, as shown in FIG. 11, single elongated organic EL panels 25 and 26 may be attached to the side plates 12 and 13. In the illuminated makeup mirror set in FIG. 9, the light-emitting surface of each of the organic EL panels 25 and 26 is divided into a plurality of regions, e.g., four regions 28a to 28d or 29a to 29d, as shown by dotted lines in FIG. 11. The controller drives each of these regions according to the input operation by the user from the operation unit in the same manner as in the driving of each panel in the above-described embodiment, and the emission color and brightness of each region are adjusted according to the scene.

### REFERENCE NUMERALS

11 Mirror unit
12, 13 Side plate
14 Support
15 Hinge mechanism
16, 17 Speaker
25, 26, 25a to 25d, 26a to 26d Organic EL panel
50R, 50G, 50B Organic EL element
69 Playback unit

1. An illuminated makeup mirror set including a mirror unit, comprising:
a surface light source with adjustable color that is used to illuminate a makeup subject;
a setting unit for setting an illumination condition for the surface light source according to an input operation;
an adjustment unit for adjusting color and brightness of the surface light source according to the illumination condition set by the setting unit;
a speaker; and
a playback unit that stores a plurality of musical pieces as data, plays a musical piece selected from the plurality of musical pieces according to the illumination condition and time of illumination the surface light source, and causes the speaker to output the selected musical piece as a reproduced sound.

2. The illuminated makeup mirror set according to claim 1, wherein
the plurality of musical pieces are pre-classified and stored according to the length of illumination time according to the illumination condition, and
the playback unit measures the illumination time, selects a musical piece corresponding to the measured illumination time from a group of musical pieces that correspond to the illumination condition and are among the plurality of musical pieces, and plays the selected musical piece.

3. The illuminated makeup mirror set according to claim 2, further comprising a recognition unit for recognizing a degree of progress of makeup on the makeup subject,
wherein the playback unit obtains the degree of progress of the makeup from the recognition unit as information corresponding to the illumination time, selects a musical piece corresponding to the degree of progress of the makeup recognized by the recognition unit from the group of musical pieces that correspond to the illumination condition and are among the plurality of musical pieces, and then plays the selected musical piece.

4. The illuminated makeup mirror set according to claim 1, wherein the setting unit selects one illumination condition from a plurality of preset illumination conditions according to the input operation and sets the selected illumination condition.

5. The illuminated makeup mirror set according to claim 1, further comprising a side plate disposed at a side edge of the mirror unit such that an angle of the side plate with respect to the mirror unit is adjustable, and wherein the surface light source and the speaker are attached to the side plate.

6. An illumination set including a mirror, comprising:
one or more surface light sources;
a setting unit configured to set an illumination condition for the one or more surface light sources according to an input operation;
an adjustment unit configured to adjust the one or more surface light sources according to the illumination condition set by the setting unit;
a processing unit configured to selectively play a musical piece selected from a plurality of musical pieces according to the illumination condition of the one or more surface light sources; and
an output unit configured to output the selected musical piece as a reproduced sound.

7. The illumination set according to claim 6, further comprising:
a storage configured to store the plurality of musical pieces as data,
wherein the processing unit is configured to select the musical piece from the plurality of musical pieces stored in the storage.

8. The illumination set according to claim 6, wherein the plurality of musical pieces are pre-classified and stored in groups according to a length of illumination time and the illumination condition, and
the processing unit is configured to measure the illumination time, select the musical piece from a group of the musical pieces that corresponds to the illumination condition, and play the selected musical piece.

9. The illumination set according to claim 8, further comprising:
a recognition unit configured to recognize a degree of progress of makeup application on a subject image that is reflected in the mirror,
wherein the processing unit is configured to obtain a degree of progress from the recognition unit as information corresponding to the measured illumination time, select a musical piece corresponding to the degree of progress, the musical piece selected from the group of musical pieces that correspond to the illumination condition, and play the selected musical piece.

10. The illumination set according to claim 6, wherein the setting unit is configured to select one illumination condition for the one or more surface light sources from a plurality of preset illumination conditions according to the input operation and set the selected illumination condition.

11. The illumination set according to claim 6, further comprising one or more side plates disposed at one or more side edges of the mirror,
wherein at least one of the one or more surface light sources is disposed on at least one of the one or more side plates.

12. The illumination set according to claim 11, wherein a loudspeaker is disposed on at least one of the one or more side plates.

13. The illumination set according to claim 11, further comprising a flexible hinge mechanism configured to attach at least one of the one or more side plates to a side edge of the mirror such that an angle of the side plate with respect to the mirror is adjustable.

14. An illumination set including a mirror, comprising:
one or more surface light sources;
a setting unit configured to set an illumination condition for the one or more surface light sources according to an input operation;
an adjustment unit configured to adjust the one or more surface light sources according to the illumination condition set by the setting unit;
a processing unit configured to selectively play a musical piece selected from a plurality of musical pieces according to a time of illumination of the one or more surface light sources; and
an output unit configured to output the selected musical piece as a reproduced sound.

15. The illumination set according to claim 14, comprising:
a storage configured to store the plurality of musical pieces as data,
wherein the processing unit is configured to select the musical piece from the plurality of musical pieces stored in the storage.

16. The illumination set according to claim 14, further comprising a recognition unit configured to recognize a degree of progress of makeup application on a subject image that is reflected in the mirror,
wherein the processing unit is further configured to obtain a degree of progress from the recognition unit as information corresponding to the measured illumination time, select a musical piece corresponding to the degree of progress from a group of musical pieces that correspond to the measured illumination time, and play the selected musical piece.

17. The illumination set according to claim 14, wherein the setting unit is configured to select one illumination condition for the one or more surface light sources from a plurality of preset illumination conditions according to the input operation and set the selected illumination condition.

18. The illumination set according to claim 14, further comprising one or more side plates disposed at one or more side edges of the mirror,
wherein at least one of the one or more surface light sources is disposed on at least one of the one or more side plates.

19. The illumination set according to claim 18, wherein a loudspeaker is disposed on at least one of the one or more side plates.

20. The illumination set according to claim 18, further comprising a flexible hinge mechanism configured to attach at least one of the one or more side plates to a side edge of the mirror such that an angle of the side plate with respect to the mirror is adjustable.
